(19) United States
(12) Patent Application Publication
(10) Pub. No.: US 2008/0304639 A1
(43) Pub. Date: Dec. 11, 2008

(54) SYSTEM AND METHOD FOR COMMUNICATING WITH INTERACTIVE SERVICE SYSTEMS

(75) Inventors: John McDonough, La Jolla, CA (US); Raj Oswal, Rancho Santa Fe, CA (US)

Correspondence Address: PROCOPIO, CORY, HARGREAVES & SAVITCH LLP, 530 B STREET, SUITE 2100, SAN DIEGO, CA, 92101, US

(73) Assignee: SMARTTOUCH, INC., La Jolla, CA (US)

(21) Appl. No.: 12/122,535

(22) Filed: May 16, 2008

Related U.S. Application Data
(60) Provisional application No. 60/938,965, filed on May 18, 2007.

(51) Int. Cl. H04M 11/00

(52) U.S. Cl. 379/93.01

(57) ABSTRACT

An interaction system is described, which can reside on a cellular phone, a personal data assistant (PDA), a laptop computer, or any general purpose computing device. The interaction system provides a greatly simplified user interface for communication with interactive service systems. The interaction system builds the user interface by interpreting an associated profile that enables a user to access the interactive service system. The entire menu system of the interactive service system is presented to the user in a simple and easy to navigate set of menus, user input prompts and audible outputs of requested user information and confirmations. The interaction system saves time and minimizes user entry errors. The system leverages existing interactive service systems while taking full advantage of computing device features.

### CROSS-REFERENCE TO RELATED APPLICATIONS

This application claims the benefit of priority of co-pending U.S. Provisional Patent Application No. 60/938,965, filed May 18, 2007, entitled “System and Method for Communicating with Interactive Service Systems.” The disclosure of the above-referenced patent application is hereby incorporated by reference.

### BACKGROUND

1. Field of the Invention

The present invention relates to communication with interactive service systems, such as interactive voice response (IVR) systems, service systems that use short message service (SMS), and websites or other data systems.

2. Related Art

Many companies currently use interactive service systems, such as IVR systems for various tasks as a first line of customer support and service. Typically, a customer calls in to a company's IVR system via a telephone. The IVR system answers the telephone call and a computer-controlled voice prompt interacts with the user. The computer controlled voice prompt is typically under the control of a script (a predefined process, e.g., software) running in the background. The script causes the IVR system to present options to the caller in the form of a series of questions or statements. The caller answers the series of questions usually by pressing buttons on their telephone or by answering the questions verbally. As the user answers the questions, the IVR interprets their answers and proceeds through a hierarchy (e.g., an IVR menu system), gradually narrowing down the potential issue that the customer has called the IVR system about and/or providing the customer with the information that they are looking for.

Current IVR systems have many limitations. For example, the user incurs long delays while the IVR system lists the menu options. Furthermore, the user must recall the numbers associated with the menu items in order to make a selection. Poor performance of voice command IVR systems is also prevalent due to technology limitations, background noise, and user accent variations. Voice systems also may require the user to speak private information into the telephone, which is undesirable, especially in public places like airports, parks, or restaurants. Users may also need to look up account information (e.g., a frequent flyer number or credit card number) in order to complete certain transactions, which is inconvenient.

Limitations in voice recognition systems, as well as poor design, can also lead to customers exiting the IVR system altogether. For example, customers who are not satisfied with the IVR system may oftentimes press “0” on their telephone (or another applicable input button), which may connect them to a live customer service representative. The cost for a company to connect the customer to a live customer service representative is very high so there is a large desire within companies to minimize such a response from the customer.

Therefore, what is needed is a system and method that reduces or overcomes these significant problems found in the conventional systems as described above.

### SUMMARY

Embodiments described herein provide for a system and method for communicating with interactive service systems. In one aspect, an interaction system resides on a web site or server and is available for downloading to a client device, such as a cellular phone, a personal data assistant (PDA), a laptop computer, or any general-purpose computing device. In another embodiment, the interaction system resides on a server and provides its functionality to a user via a website.

The interaction system provides a simplified user interface for communication with service systems, such as IVRs. The interaction system builds the user interface by interpreting an associated profile that enables a user to access the system (e.g., a touch-tone banking system, an airline reservation system, a self-service customer care system, etc.) in a graphical and textual manner, rather than the traditional manner associated with such service systems (described above). In one embodiment, a profile creation tool (module) is used to create the profile.

In an embodiment, the interaction system presents an IVR menu system to the user in a simple and easy to navigate set of menus, user input prompts and audible outputs of requested user information and confirmations. The user input prompts may also be audible. The interaction system saves time and minimizes user entry errors. The interaction system leverages existing IVR systems while taking full advantage of client device features (e.g., keypad, touch screen, scroll wheel, pointing device, speaker, microphone, display screen, etc.).

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of a system, which is used to communicate with a script executing on an IVR system according to one embodiment.

FIG. 2 is a diagram of a process, which is used to communicate with IVR systems according to one embodiment.

FIG. 3 is a block diagram of an IVR interaction system for communicating with IVR systems and a client system according to one embodiment.

FIG. 4 is a diagram of a process, which is used to communicate with a script executing on an IVR system according to one embodiment.

FIG. 5 is a diagram of a process, which is used to save entry shortcuts according to one embodiment.

FIG. 6 is a diagram of a process, which is used to save sequence shortcuts according to one embodiment.

### DETAILED DESCRIPTION

Certain embodiments as disclosed herein provide for a system and method for communicating with interactive service systems, such as an IVR system. As used herein, the term IVR system generally refers to a system, which includes a script or other software resident on a server or a computing platform. The IVR system is operably connected to a telephone network, including landline, cellular, and VOIP telephone networks. The script is capable of receiving and interacting with input via a communication or signal transmitted over a telephone network. For ease of understanding, most of the following description refers to embodiments directed to IVR systems. However, the embodiments can also be applied or used with other varieties of interactive service systems.

After reading this description, it will become apparent to one skilled in the art how to implement the invention in various alternative embodiments and alternative applications. Although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

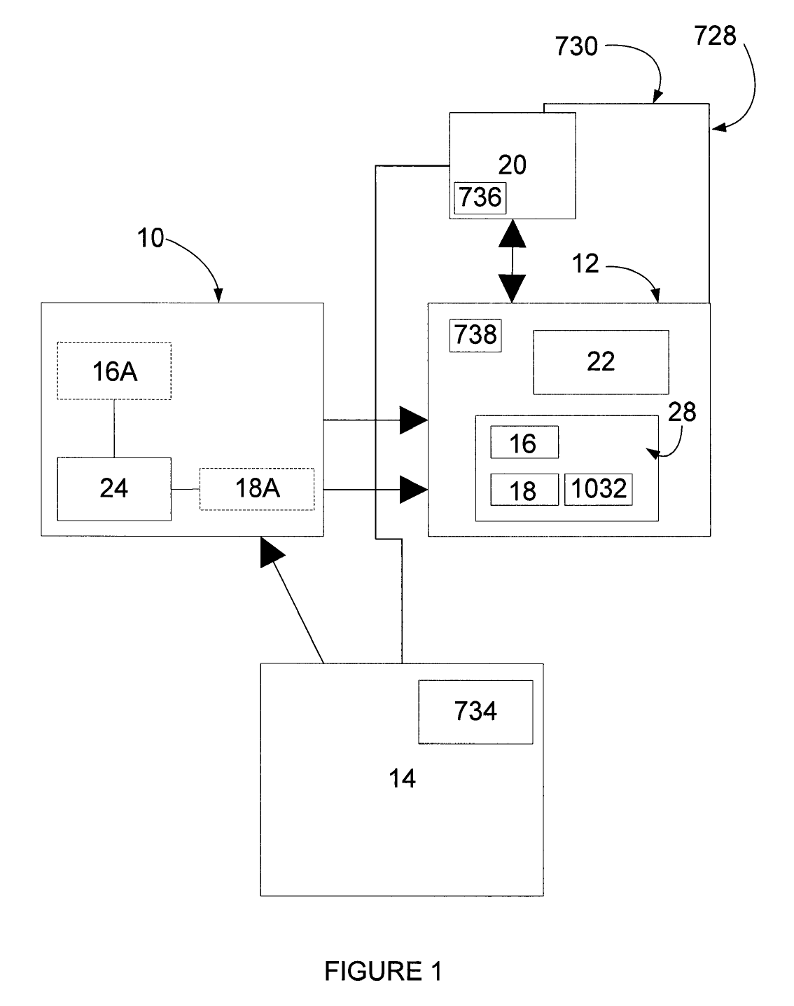

FIG. 1 is a block diagram of an embodiment of a system, which is used for communicating with interactive service systems. It should be noted that certain components (e.g., processors, network ports, memories, buses, and transceivers), which are typically included by the elements and modules depicted in FIG. 1 and subsequent figures, have been omitted for ease of description. It will be noted that these omitted components would be recognized as being included in the modules and functional blocks in a manner commonly known to those skilled in the art.

A server 10 can be a server in a conventional client-server architecture or it can be a web site, a web server, or the like. An IVR interaction system 16 is typically software initially resident on the server 10 (where it is indicated as 16A), and downloaded to the client device 12 where it resides in memory 28. The memory 28 includes Random Access Memory (RAM), Read Only Memory (ROM), flash memory, a fixed memory device, a removable memory device, and the like. A profile creation module 14 can be a computer program, which allows a designer, a system administrator, or a company to create a profile 18. High-level information related to an IVR script residing on an IVR system 20 is entered into the profile creation module 14, which creates the profile 18 in accordance with the information. The profile creation module 14 outputs the profile 18 in a predefined format, for example using extensible markup language (XML) or another suitable language and/or file format. FIG. 1 shows the profile creation module 14 as a separate block, but it can also be resident on the server 10 or on another computer. The profile 18 can be loaded onto the server 10 (indicated therein as 18A) after it is created using the profile creation module 14, and downloaded to the client device 12, where it resides in memory 28. The profile 18 may also be in a compressed and/or an encrypted form.

Generally, the profile 18 corresponds to one script associated with the IVR system 20. There may be many profiles on the server 10 or a client device 12, each profile corresponding to a script associated with an IVR system 20 that a client device 12 may access. For example, a server 10 may have profiles associated with banks, movie theaters, and take-out restaurants available to be downloaded onto a client device 12. In an embodiment, each profile 18 is a compact representation of the possible interactions with a particular script on an IVR system 20. This may include menu tree and menu item information, user input requirements, and information necessary to determine when the IVR system 20 provides audible output to the user. The profile 18 also contains the telephone number(s) used to connect to the IVR system 20. Although the current example of the profile 18 represents the script on the IVR system as a tree, the profile 18 can use other data structures to represent the script as well. A profile may specify communications over any type of communications channel, including voice, data (e.g., using data packets), and SMS channels.

The client device 12 can be, for example, a cellular phone, a smart phone, a landline phone, a cordless phone, a PDA, a pager, a laptop, or any general purpose-computing device. In an embodiment, the client device 12 is able to access the IVR system 20 via a telecommunications network using telephony hardware 738, includes a display, and is able to download at least one profile 18. The telephony hardware 738 is used to establish a telephone based connection to the IVR system 20 and can be, for example, wireless telephone (cellular) hardware, wired telephone hardware, or voice over Internet protocol (VOIP) hardware. In an embodiment, the client device 12 accesses the server 10 via a voice and/or data channel and the server 10 accesses the IVR system 20 via a voice or VOIP connection.

The client device 12 includes the IVR interaction system 16 and the profile 18 after it downloads them into its memory 28 from the server 10. Thereafter, the client device 12 executes or runs the IVR interaction system 16. The IVR interaction system 16 processes the profile 18 to generate a user interface (graphical and/or audible), and uses the telephone based connection established by the telephony hardware 738.

Interaction hardware 22 (such as a display) on the client device 12 generates the user interface when the IVR interaction system 16 processes the profile 18. The user interface is a bi-directional interface for displaying information to the user, and receiving input from the user using the interaction hardware 22 on the client device 12, (for example, a mouse, keypad, touch screen, scroll wheel, speaker, microphone, external interface device such as a Bluetooth headset, etc.) For example, if the IVR system 20 represented by the profile 18 includes the voice prompt “Press 1 for English or press 2 for Spanish,” the user interface graphically represents those options via a display on the client device 12 where the user interface is presented.

The user interacts with the IVR system 20 through the user interface generated on the client device 12, thereby avoiding many drawbacks associated with the conventional IVR system 20. When the user's interaction with the user interface requires the IVR interaction system 16 to send a signal or communication, the IVR interaction system 16 causes the client device 12 to output the signal which is routed over a telecommunications network and received at the IVR system 20. In an embodiment, the signal is a dual tone, multi frequency (DTMF) signal generated by the client device 12 or elsewhere in the telecommunications network. The DTMF signal has the same effect at the IVR system 20 as would be achieved had the user called directly in the conventional manner with a telephone and pressed a key on the phone in response to a voice prompt from the IVR system 20.

In an embodiment, the IVR interaction system 16 can process information received from the IVR system 20. For example, the IVR system 20 sends information acknowledging receipt of input from the IVR interaction system 16 and/or indicating the current location within the script it is executing. The IVR interaction system 16 can also receive feedback indicating that an error condition has occurred (e.g., a user data entry input such as a user account number is invalid, or a DTMF tone is not recognized as corresponding to a valid menu item), accompanied with an error condition connection 730. The error condition connection 730 can be the same connection that the client device 12 uses to send the DTMF signal to the IVR system 20, and that IVR system 20 uses to send audio to the client device 12s. Other methods of such handshaking may be employed for further protection against errors and conditions under which the IVR system 20 and the IVR interaction system 16 may lose synchronization. For example, the user may be provided a “back” option to help maintain synchronization.

The IVR interaction system 16 may receive information from the IVR system 20 as to the version number of the IVR system 20 that the IVR interaction system 16 is accessing. This information allows the IVR interaction system 16 to determine if the profile 18, which resides on the client device 12, is out of date with respect to the IVR system 20. If the profile 18 is out of date, the IVR interaction system 16 may prompt the user to update the profile 18 prior to calling into the IVR system 20. The profile 18 contains the version number, which corresponds to a particular version of the IVR system 20. In an embodiment, the profile creation module 14 is used to put version number information into the XML comprising the profile 18. The IVR system 20 has knowledge of its version number. When the client device 12 connects to the IVR system 20, the IVR system 20 sends its version number and the IVR interaction system 16 performs a comparison. If the version numbers for the profile 18 and the IVR system 20 are not the same, then the profile 18 is out of date with respect to the IVR system 20. The IVR interaction system 16 may also track and log calls made to the IVR system 20 for billing purposes.

In an embodiment, the IVR system 20 is configured to output information describing, for example, menu trees, user entry fields, and data files. The information can then be received and post-processed at the profile creation module 14 to generate all or part of a profile, thus simplifying the profile creation process. The profile creation output module 734 may then be used to output the profile.

The IVR interaction system 16 may receive via a transaction summary module 736 a summary of, or information related to, the IVR system transactions performed by the user. The summary may be sent to the user's client device 12 by way of a text message (SMS, for example) containing a listing of the specific transactions and data accessed. For example, an IVR system 20 related to banking may send the user's savings and checking balances, a confirmation of a transfer between checking and savings, and the transfer amount if the user performed such transactions. The IVR interaction system 16 may include a scheduled call module 1032. The scheduled call module 1032 can invoke a scheduled call feature so that it can automatically connect to the IVR system 20 on a recurring basis. Using the transaction summary module 736 along with the scheduled call feature in the scheduled call module 1032, a user can receive daily, weekly, or monthly account balance information to the user's client device 12.

The IVR interaction system 16 may periodically receive information at the user's client device 12, which the IVR interaction system 16 can use to supplement, change, or augment the information already contained in the profile 18 corresponding to the IVR system 20. For example, a profile 18 for a cinema can have periodic updates sent to update information as to specific movies playing and show times. Also, minor changes, updates and corrections to a profile 18 can be sent in this way. The IVR system 20 may provide a way for a user to acquire the profile 18 for the IVR system 20 through the IVR system 20 itself. For example, the IVR system 20 may store the profile 18 and provide it to the client device 12.

The IVR interaction system 16 can receive updates to the profile 18 in a number of ways. For example, the IVR system 20 may send a text/SMS message to the client device 12, and/or the IVR system 20 may perform a handshake with the client device 12, such as described above with respect to the error condition connection 730. The IVR interaction system 16 may also receive updates to the profile 18 via a data connection between the server 10 and the client device 12 or from another server.

Updating the profile 18 on the client device 12 with the IVR interaction system 16 may occur in a number of ways. For example, a new profile may completely replace the old profile. Alternatively, new attribute values within the profile 18 may replace old attribute values. The IVR interaction system 16 can load the updated information and profile into memory for the purpose of changing one or more attribute values or the entire profile 18.

The IVR interaction system 16 supports multiple languages since the majority of the user interface is in written/textual form. In an embodiment, the IVR interaction system 16 provides a user interface with a menu list having language choices, and uses the user language selection when displaying the user interface for the profile 18. In addition various single language profiles are supported. In this way languages that are not even supported by the associated IVR system 20 can be supported by the profile 18 when the profile 18 is prepared in the described language.

There are a number of methods for loading the profile 18A on the server 10 into the client device 12, which can be implemented by the download module 24. For example, the user can log in to the server 10, and provide through an interface on the server 10 the telephone number associated with the client device 12 (e.g., a cellular phone). The server 10, or the web site associated with the server 10, then sends a text message to the client device 12. The text message contains the URL, which points to the profile 18. When the user accesses the text message and selects the URL contained therein, the client device 12 is directed to the URL.

Upon accessing the site corresponding to the URL, the user is prompted to download the profile 18. The user follows directions at the site, generally including the selection of a link which initializes the download. Once selected, the profile 18 is downloaded to the client device 12. The user may then locate the profile 18 and selects it. Selecting it generally causes the file to be placed in an appropriate file location on the client device 12. The location may be defined by information contained in the file. In an embodiment, the file may downloaded in an encrypted and/or compressed form, and the client device 12 is configured accordingly to decrypt and/or uncompress the file.

The profile 18 may be placed in a location in which it is recognized by the IVR interaction system 16 as a new profile 18. The profile 18 may also be loaded onto the user's PC (not shown), and then to the user's client device 12. Loading from the PC to the client device 12 may be performed using a cable, (e.g., universal serial bus (USB) cable), or wirelessly (e.g., Bluetooth), or by other means. Thereafter, the user is allowed to access the associated IVR system 20 using the IVR interaction system 16. It is also possible that a user logging into the server 10 (e.g., through its associated web site) is able to determine if a profile 18 is available for a particular IVR system 20 by entering or searching for the telephone number of the IVR system 20 and/or by entering or searching for the name of the associated company and/or by searching by category.

The user can also grant the server 10 access to the user's contact list in the user's client device 12 or PC (not shown) so that the server 10 can search for profiles 18 that are available for any of the contacts listed and offer the user the opportunity to download any or all of them to the user's client device 12 as described above. For example, the server 10 can prompt the client device 12 or PC (not shown) to download an application that accesses the contact list and compares the contact list to the available profiles (e.g., by comparing the phone numbers). For each matching phone number, the application indicates to the user that a corresponding profile is available.

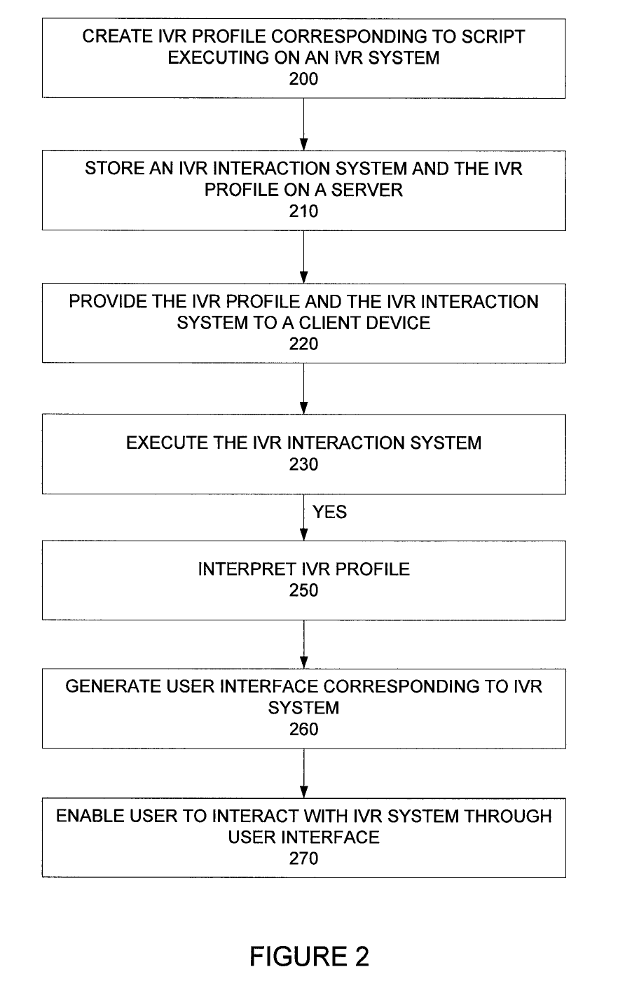

FIG. 2 is a diagram of an example process of communicating with a script executing on an IVR system 20 according to an embodiment. FIG. 2 will be described with reference to the system of FIG. 1. At step 200 a user creates a profile corresponding to the script on the IVR system 20. The user can create the profile 18 on the server 10, via a website or web server that can communicate with the server 10, or via a PC which then uses the Internet to upload it to the server 10. The profile 18 can be created by reverse engineering the IVR system 20, or from information located within the IVR system 20 itself. For example, a web site or web page of a company can provide information regarding the IVR system 20, greatly simplifying the creation of the profile 18. Once created, the profile 18 is then stored on the server or on another associated server at step 210. The profile 18 is stored along with the IVR interaction system 16.

In an embodiment, a bank using an IVR system 20 provides a page or link within its web site. The page describes the IVR interaction system 16 and prompts the user to indicate interest in downloading the IVR interaction system 16 (unless the user already has the system loaded on a client device 12). The page then prompts the user for the user's cellular phone number (i.e., the telephone number of the client device 12) and other information. The user is allowed to download the profile 18 for the bank's IVR system 20 onto the cellular telephone or to the user's PC over the Internet. Alternatively, the user is redirected away from the bank's site and to another server where the user may register. There, the user is directed to a download page pre-configured for downloading the bank's profile. When thus redirected, it is possible to present a user experience wherein the bank's brand is present during the entire download process, such that the user remains unaware of being redirected away from the bank's web page. A web site or web page of a company (not shown) may also provide a link to a web site associated with the server 10, and further to the profile 18 for the company's IVR system 20. A user can log into the web site associated with the server 10 (if already registered there) and navigate or be directed to the profile 18 of interest, or be queried to register with the server 10 before navigating or being so directed.

At step 220, the profile 18 and the IVR interaction system 16 are provided to a client device 12. The profile 18 and the IVR interaction system 16 may be provided, for instance, by the user accessing the server 10 or a website associated with the server 10 and downloading or otherwise being provided with the IVR interaction system 16 and the profile 18. Alternative methods of placing the IVR interaction system 16 with the profile 18 on the user device 12 can also be used. Once the IVR interaction system 16 and the profile 18 are downloaded, they now reside on the client device 12, for example, in the memory 28.

Once residing on the client device 12, the IVR interaction system 16 is executed at step 230. When the IVR interaction system 16 is being executed or run, it interprets or processes the profile 18 at step 250. As a result of the IVR interaction system 16 interpreting the profile 18, a user interface is generated at step 260. The user interface allows the user to interact with the script on the IVR system 20 in a more efficient manner. The user interface can present information graphically and textually in place of some or all of the voice functionality that creates problems with interactions with conventional IVR systems 20. The user interface can be configured to allow audio responses from the IVR system 20 to pass through to the user. Optionally, the user may be enabled at step 270 to interact with the conventional IVR system 20 through the generated user interface.

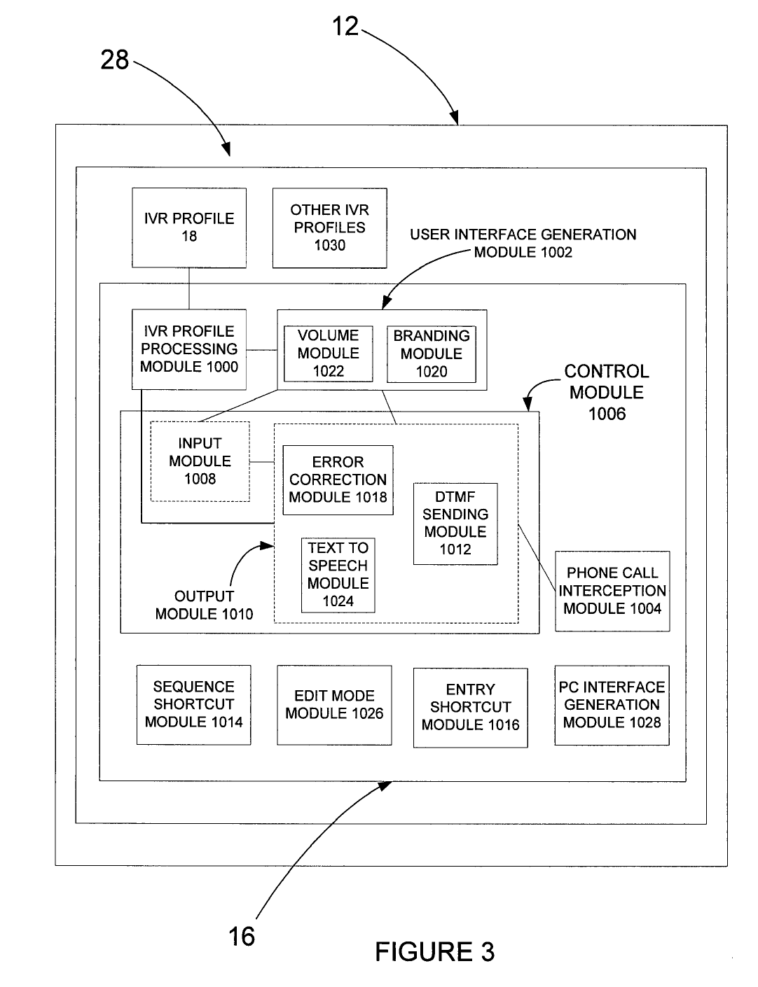

The IVR interaction system 16 shown in FIG. 1 is now described in more detail in connection with FIG. 3. The IVR interaction system 16 interprets the profiles 18 with the profile processing module 1000. The profile processing module 1000 processes the data in the profile 18 and provides information to the user via the user interface generation module 1002, which uses the provided information to build the user interfaces on the client device.

Each profile 18 has attributes which characterize it. There are several types of attributes including attributes at the profile level, at the menu level, and at the menu item level. These groups of profile attributes are then linked together through commands, such as “goto,” which tell a parser what the next menu to display based on the current menu and based on user input. An interpreter reads the information in the profile 18 (and at times writes back) to the profile.

As the user interacts with the displayed interface via the interface(s) of the client device (e.g., display screen, keypad, touch screen, joystick, mouse, scroll wheel, speaker, etc.), the user's interactions are processed by the control module 1006, so that the user may navigate a set of select menu items, input user information, interact with the IVR system 20, etc.

In general operation, a user interface displays a plurality of options for accessing a plurality of respective IVR systems over a network. User input (for example, a menu item selection or data entry) via the user interface causes the input module 1008 to communicate with the profile processing module 1000 to process a profile so that a new user interface can be generated by the user interface generation module 1002 (i.e., a user interface based on the processing of the profile).

For example, the profile processing module 1000 knows the starting point in the IVR system 20, which corresponds to the first menu in the IVR script. With each user input, the profile processing module 1000 knows which next place in the IVR script the IVR system 20 will be (since the IVR system is a state machine) and therefore which point in the IVR script it should cause to be displayed to the user via the user interface. Additionally, as the user interacts with the new user interface, the input module 1008 communicates to the profile processing module 1000. The profile processing module processes the information from the input module and sends it to the output module 1010. The output module 1010 queues an output signal to be sent at an appropriate time. The signal causes a DTMF tone to be routed to the IVR system 20.

The user need not wait for the IVR system 20 to provide the menu list for a given menu level. Instead, the items in the updated user interface can be presented immediately upon entering the particular menu level, and the user may scroll up and down and see all available menu items in a manner consistent with browsing on a computing device.

In one embodiment, when a user selects a menu item the DTMF sending module 1012 sends a DTMF signal immediately to the IVR system 20. In order to account for any delay in the IVR system script, the profile processing module 100 may delay the user interface generation module 1002 in displaying the next screen. The delay is an attribute of the profile (e.g., ½ second).

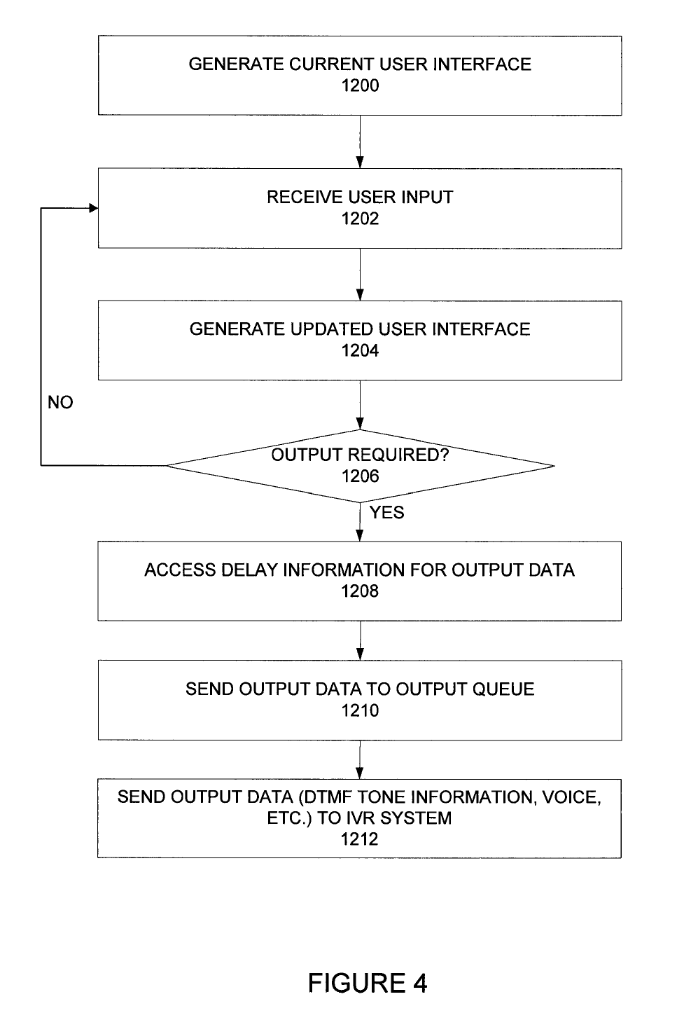

FIG. 4 is a diagram of one embodiment of a process, which is used to communicate with a script executing on an IVR system 20. At step 1200, the user interface generation module 1002 generates the current user interface. For example, if the user is at an initial call in screen, the user interface generation module 1002 generates a user interface representing the initial state of the IVR system 20 after a connection is made. At step 1202, the input module 1008 reads user input. For example, the input module 1008 may read one or more keystrokes or other input from the user via the interface on the client device 12 indicating a menu selection, for example, for “check account balance.” In such a case, the input module 1008 may indicate the selection to the profile processing module 1000 which further processes the profile 18 in view of that input.

At step 1204, the profile processing module 1000 determines from the profile 18 whether an output is required. Note that the specific menu tree structure that is viewed by the user utilizing the user interface when running the IVR interaction system 16 need not reflect the exact menu structure of the associated IVR system 20. For example, the profile 18 (as originally downloaded or as modified by the user) may indicate that a lengthy menu list at a particular menu level of the IVR script should be broken down into several smaller lists with an intermediate menu list appearing beforehand. The intermediate menu list serves to allow the user to choose from the several smaller lists. Therefore, a response to the intermediate menu list does not correspond to or require an output to be sent to the IVR system 20.

If the profile 18 indicates an abstracted menu tree (i.e., that the processing module 1000 should break a long menu into a series of menus), then no output signal, for example a message, signal, or data used to cause the generation of a DTMF tone, needs to be sent to the IVR system 20 yet. Therefore, no output is required at step 1204. In such a case, the user interface generation module 1002 only needs to update the user interface at step 1206. Thereafter, step 1202 repeats until the abstracted menu reaches a node where the profile 18 indicates that the DTMF sending module 1012 should send a DTMF output signal to the IVR system 20.

For example, for every menu item there is an attribute in the profile 18 for the output values that correspond to DTMF signals. Also, for user input screens, the user input may be sent on as DTMF signals. So the output either comes from a profile attribute for a menu item of from the user's input. There is also an attribute which is used to allow one or more DTMF signals to be appended to a user entry (e.g., the DTMF for a “#” may need to be sent immediately after the user entry is sent). If no DTMF is needed to be sent then the attribute may be null.

Returning to the example above of presenting an English menu list, the IVR interaction system 16 initiates a process by which a signal is sent to a telecommunications or telephone network instructing that a DTMF signal corresponding to the selection of “1” on a conventional telephone should be generated. The instruction causes the DTMF signal to be transmitted to the IVR system 20 so that, in general, there is a synchronization between the updating of the user interface and the state of the script executing on the IVR system 20.

Once the IVR interaction system 16 determines at step 1204 that the process of generating a DTMF tone by the telephone network is required, the DTMF sending module 1012 sends data, instructions, or signals to a telephone network, which causes the telephone network to generate the appropriate DTMF tone, which is sent to the IVR system 20 at step 1208.

Thereafter, the processing module 1000 accesses delay information for the output at step 1210. The profile 18 may contain the delay information. If the signal sent by the output module requires 1 second for the IVR system 20 to respond, for example, then a timer may be used to determine whether 1 second has elapsed at step 1212. Thereafter, the user interface generation module 1002 generates an updated user interface at step 1206 and step 1202 repeats. Alternatively, during step 1212, a signal or communication may be received from the IVR system. Then at step 1206 the updated user interface can be generated taking the signal received from the IVR system into account.

Because the IVR system 16 is intended to provide users with access to the IVR systems of both small and large corporations and entities, there is a significant ability to leverage the features of the cellular phone for enhanced and improved access to such IVR systems. In addition there is the ability for the corporations maintaining these IVR systems to take advantage of promotional, advertising and branding to the users by way of the branding module 1020, which offers features to address the promotional, advertising and branding interests of these corporations.

For example, when a call is placed for which a profile 18 is available, the IVR interaction system 16 may display a background image using the branding module 1020 at each screen. In addition at appropriate locations within the menu tree (such as in the top header at each screen) the corporate logo may be placed. Also, promotional text bars and scrolling banners may be displayed for promotional or advertising purposes at appropriate locations within the menu tree and screens. Also, the background for the menu tree and certain of the audible indications may be designed with the branding interests of the corporation in mind (e.g., a “chu-chu” train sound for train company or a “cha-ching” sound for a bank.

Depending on the business model, the telephone call interception module 1004 may intercept calls to particular IVR systems, where the call is placed instead to an intermediate IVR system, and whereby the intermediate IVR system places a second call to the IVR system 20 so that the two IVR systems are in series. In this manner, the call from the client device 12 via the IVR interaction system 16 can be monitored and altered at the intermediate IVR system for purposes of user and/or customer billing and audit records creation, call volume and statistics collection, profile version control, user registration verification, voice recognition and text to speech operations, error and synchronization detection and correction, advertisement downloads, etc. In an embodiment, an intermediate server performs the functions described for the intermediate IVR system.

The IVR interaction system 16 provides added benefits to the user not typically available with IVR systems, such as the ability to clear a user entry or delete parts of a user entry prior to the user entry information being sent to the IVR system 20. In addition, user input may be formatted as the user is entering it. In this manner, the user may see clearly that the input they are providing is correct. Such formatting may include $ signs, decimal points, indication of month, day and year entries, etc. The IVR interaction system 16 is also capable to check for errors in the user input via the error correction/checking module 1018 (erg., improper characters, too many digits, too few digits, improper values, etc.) to the extent such limitations are known when the profile 18 is created. The IVR interaction system 16 is capable of indicating the existence of incorrect entry data via the user interface generation module 1002 and can prompt the user to correct it before the DTMF sending module 1012 sends any incorrect DTMF tones to the IVR system 20.

When appropriate, the IVR interaction system 16 may make use of pop-up calendars and a pop-up alpha-numeric entry pad as well as other pop-up applications to make the user entry quick, error free, and convenient. For entry items which the user may consider private, the IVR interaction system 16 may hide the entry (e.g., use the “*” symbol for PIN number digits and for all but the last 4 digits of credit card numbers, etc.).

When a user provides user entry information to the IVR system 20, the IVR interaction system 16 may use the volume module 1022 to un-mute the receive audio path from the IVR system 20 to the user briefly in order that the user hears any indication of an error in the information provided to the IVR system 20 (e.g., an incorrect account number). Should the user hear such an error indication, the user has the option to exit the IVR interaction system 16 and continue the connection to the IVR system 20 in a manual mode as is currently used to interface with IVR systems. Alternately, when consistent with the behavior of the IVR system 20, the user may use a “Back” key or soft key, for example, provided as part of the user interface in order to go back to the menu in which the entry was made and to then correct the entry and resend the corrected value to the IVR system 20.

Attributes in the profile 18 contain information required for the volume module 1022 to mute and un-mute the outgoing and incoming audio. The volume module 1022 typically mutes outgoing audio (from the user to the IVR system 20) in order to avoid background noise from entering the IVR system 20 and interfering with any voice recognition or DTMF detection software or algorithms which may be running on the IVR system 20. Note that the volume module 1022 can be configured to substantially lower the volume of the audible output of the IVR system 20 rather than completely mute it, so that the user can still hear the audible output when the user interface generation module 1002 updates the user interface, but such that it does not interfere with the user's interaction with the user interface.

In general, the IVR interaction system 16 mutes (or substantially reduces the volume of) the audio from the IVR system 20 corresponding to menu item listings, user input prompts, etc., so that the user may concentrate on the graphical menu items in the user interface and input prompts provided by the IVR interaction system 16.

When the IVR system 20 is to provide information to the user such as account balance information, flight time information, user input confirmations, transaction confirmations, confirmation numbers, etc., the volume module 1022 can automatically un-mute (or increase the volume of) the audio from the IVR system 20 so that the user may hear the audio output from the IVR system 20.

In such cases the user interface generation module 1002 can cause the user interface to present appropriate icons and/or audible indications to indicate to the user that audible output is being provided by the IVR system 20. In cases where the time duration of the output from the IVR system 20 is variable or the duration is not known, the volume module 1022 is capable of un-muting for an indeterminate period of time until the user indicates that the IVR interaction system 16 should move on to the next menu or user interface.

The volume module 1022 may be enabled on a call by call basis according to the user's preferences. The user can also request that the IVR interaction system 16 record some or all of the outputs of the IVR system 20 for access by the user at a future time. The volume module 1022 can be used in either a speakerphone mode, a handset mode, or using a headset, such as a Bluetooth headset, in order to allow the user to be in a hands free mode. This use model gives the user the best opportunity to view the display and manipulate the keypad while at the same time listening to the output of the IVR system 20 as required.

In certain cases, the profile 18 requested by and provided to a user can contain certain information specific to the user. For example, in a banking example, the profile 18 can contain the user's account number and account suffixes for savings and checking accounts as “entry shortcuts.” The user would see the entry shortcuts upon a first call into the IVR system using the IVR interaction system 16. This user specific generation of the profile 18 provides benefits to the user by reducing the frequency of errors in user data entry and adds to the convenience of the system.

When a user calls into an IVR system in which there is no profile available, the IVR interaction system 16 can monitor the user's entry sequence and prompt the user the save certain of the entries as a “sequence shortcut.” In such a case, the IVR interaction system 16 auto-generates the profile 18 containing the sequence shortcut so that the IVR interaction system 16 would be started the next time the telephone number of the IVR system 20 is dialed. The user may choose to save the sequence shortcut only in certain specific cases (e.g., when the user dials into an IVR system 20 and immediately enters the extension of the person the user wished to speak to—in which case the user may save the sequence shortcut with the name of the person whose extension was entered).

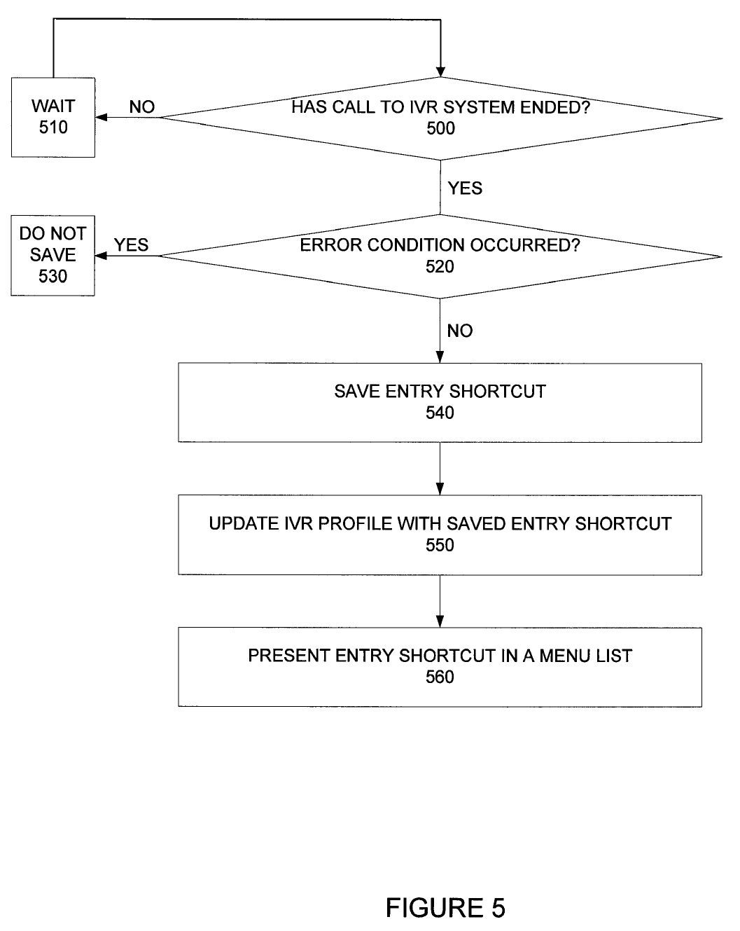

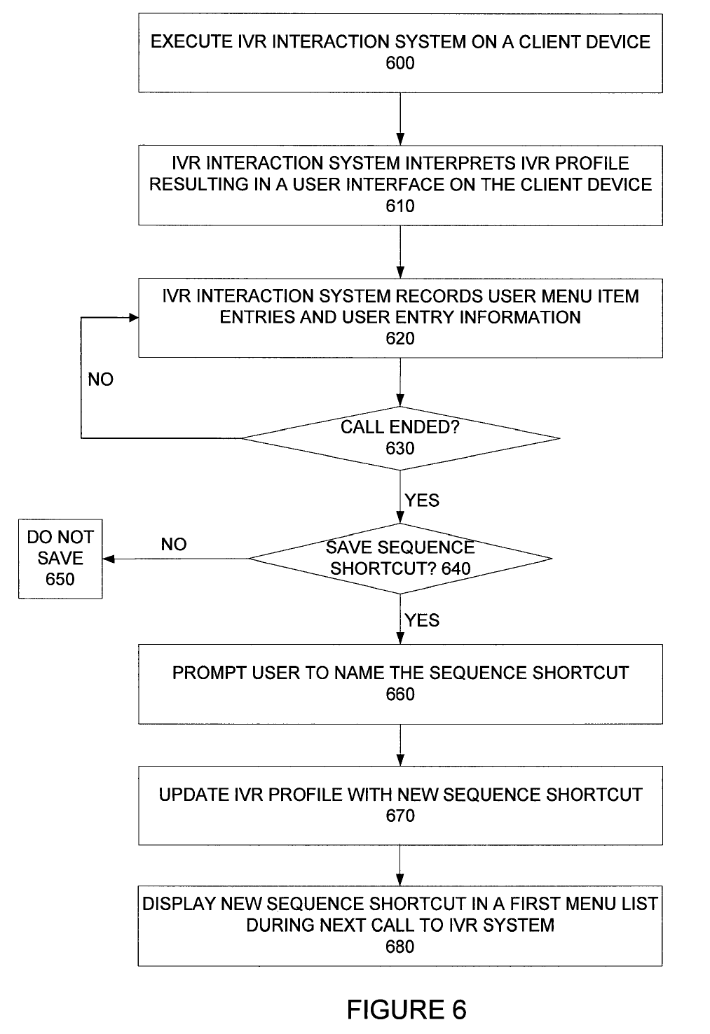

The use of entry shortcuts and sequence shortcuts will now be described with respect to FIGS. 5 and 6. FIG. 5 is a diagram of one embodiment of a process used to save entry shortcuts. The entry shortcut module 1016 of FIG. 3 can carry out the process of FIG. 5. At step 500, the IVR interaction system 16 determines when a user has completed a call to an IVR system. If the call to the IVR system is not complete, the IVR interaction system 16 waits at step 510. The IVR interaction system 16 temporarily saves information entered by the user (e.g., in response to the user interface) during the wait at step 510. The temporarily saved information is intended to provide further convenience to the user as well as speed up transactions performed by the user and reduce the frequency of user entry errors.

For example, when during a call the IVR interaction system 16 prompts the user to enter certain information (e.g., a 5-digit ZIP code), it denotes the entered information at step 500 as having the potential to be saved as an entry shortcut when the user ends the call, unless it detects one of a number of potential error conditions at step 520. If the IVR interaction system 16 detects one of the error conditions, it will not save the entry shortcut at step 530 when the user ends the call. Otherwise, it saves the entry shortcut(s) at step 540. At step 550, the IVR interaction system 16 uses the saved entry shortcut to update the profile 18. Then, at step 560 the saved entry shortcut appears in a menu list corresponding to the menu list in which the user information was entered the next time a call is placed to the IVR system 20 and the updated profile 18 is interpreted.

Entry shortcut information is saved for user entry items that are typically static such as account numbers, etc. This saves the user time because otherwise they may need to look up this static, but not remembered, information (e.g., a bank account number or VISA card number) from another location (e.g., a VISA card in the user's wallet).

For user entry items which are variable, such as dollar amounts and dates, the information is typically not saved as an entry shortcut. The IVR interaction system 16 allows the user to designate certain of these variable user entry items as constants and allows them to be saved as entry shortcuts, however. The purpose for this designation is to allow, for example, a shortcut to be generated, which provides for the transfer of a fixed amount (e.g. $1,000.00) from one account to another and to allow such amount to be used in a sequence shortcut (defined further below) without prompting the user for such input during the running of the sequence shortcut.

The profile 18 provided to the user may be set up beforehand to include certain sequence shortcuts and entry shortcuts which may be deemed of interest to the user. For example, in the banking related profile 18 a sequence shortcut “Checking Balance” can be provided since it would seem that the checking balance transaction would be a frequently selected transaction for the IVR system 20. In a banking related profile 18, an entry shortcut “My Account: 123456789” (where 123456789 represents the user's account number) can be provided, and would save the user the time and potential for error in entering the user's account number later. In this example, the nickname “My Account” is provided by the user.

The second type of shortcut, referred to as a “sequence shortcut” will now be shown in further detail. FIG. 6 is a diagram of one embodiment of a process, which is used to save sequence shortcuts. The sequence shortcut module 1014 of FIG. 3 can carry out the process of FIG. 6. At step 600, the client device 12 executes or runs the IVR interaction system 16. At step 610, the IVR interaction system 16 interprets the profile 18, which results in the client device 12 displaying a user interface to the user.

While in the call the IVR interaction system 16 records the user menu item entries and user entry information at step 620. For example, the user may traverse several screens related to a banking transaction, such as the “Checking Balance” transaction, which are recorded. At step 630, the IVR interaction system 16 determines if the user has ended the call. If not step 620 repeats until the user finishes the call to the IVR system 20. Thereafter, at step 640 the IVR interaction system 16 prompts the user whether to save the series of inputs as a sequence shortcut.

If not, the call ends and the sequence shortcuts are not saved at step 650. Otherwise, the IVR interaction system 16 prompts the user to name the sequence shortcut at step 660. The IVR interaction system 16 adds the sequence shortcut information to the profile 18 at step 670. If saved, the sequence shortcut then appears in the initial menu list the next time the user places a call to the IVR system at step 680. While entry and sequence shortcuts can be placed in an initial menu of the profile 18, they may also be moved by the user to the initial menu of the IVR interaction system 16 or even to a cellular phone programs screen/desktop, for example.

The IVR interaction system 16 can automatically re-order each menu list. Each time the user places a call to an IVR system 20, the IVR interaction system 16 can place the menu items in each menu list at each level in the menu tree in order of frequency of use so that the most frequently selected menu items appear at the top of the menu list. After the user creates each entry shortcut or sequence shortcut, the IVR interaction system 16 may place it at the top of the appropriate menu list as if it were the most frequently used menu item and it may or may not thereafter order it according to the future frequency of use, if desired. Initially the ordering follows the order provided in the original IVR system in most cases. Reordering may be turned on or off at each menu level during the creation of the profile 18. The user may revert to the original ordering for any profile in the IVR interaction system 16. The user may also stop the re-ordering process at any time.

The user may also escape from the IVR interaction system 16 at any time in order to enter a manual IVR mode (e.g., in order to deal with any user detected synchronization error between the IVR interaction system 16 and the IVR system).

The IVR interaction system 16 also allows the user to designate certain fixed user entry items as dynamic at the time of entry and during the creation of a sequence shortcut so that such entry item will not be saved as an entry shortcut. The purpose for this designation is to allow, for example, a sequence shortcut to be generated which provides for local traffic information by prompting the user for the user's current ZIP code (e.g., Anaheim—92805) instead of using the ZIP code entered when the sequence shortcut was created (e.g., the user's home ZIP code, e.g., La Jolla—92037). The two designations above allow for entry values designated as fixed to be variable for purposes of sequence shortcuts using them and for entry values designated as variable to be fixed for purposes of sequence shortcuts using them.

Certain generic profiles can also be developed, providing the user with access to the user's account information and other information in a hierarchical menu tree, and allowing entry of new user information through the saving of entry shortcuts. For example, a user's VISA number and expiration date may be available in such a generic profile so that the user may access such VISA information at any time when connected to any IVR system and “send” the VISA information via DTMF at the appropriate times as prompted by such an IVR system.

The IVR interaction system 16 also provides an auto-entry shortcut that allows a user to indicate that a certain menu item within a given menu list is always to be selected. For example, if the user is asked to select between English and Spanish at a particular menu level in an IVR system, the user may choose English and may indicate that this selection is to be made each time the user encounters this menu list. The auto-entry shortcut may be used for a user account number, for example, which many never change and which must be entered each time the user has reached the same menu level of the IVR system 20. The IVR interaction system 16 then automatically makes the entry each time the menu list is present.

The IVR interaction system 16 also allows the user to schedule a sequence shortcut to be run at one time or on a recurring basis in the future. Using such a feature, the user is able to, for example, schedule a transfer of funds from the user's checking account to the user's savings account on a particular day and time in the future. The IVR interaction system 16 detects that the scheduled call is required, places the call, and executes the selected sequence shortcut. In such a case it is assumed that a confirmation is provided to the user that the call was placed or that the user is prompted for the transfer amount or to confirm the transaction or both.

If the IVR system called in such a case is capable to provide a confirmation of transactions by way of a text message (i.e., an SMS message) the user experience can be greatly enhanced for such scheduled calls. As an alternative, recording the confirmation and providing the recorded confirmation to the user and/or allowing the user to listen at a later time to the recorded confirmation is very convenient for the user. The IVR interaction system 16 also allows for scheduled sequence shortcuts to be run after the user is first interrupted (e.g., by an audible alert from the cell phone) and after the user approves of such sequence shortcut being run at such a time.

Referring again to FIG. 3, a user's access to the various IVR systems 20 for which the user has a profile 18 continues over time with entry shortcuts and sequence shortcuts added from time to time to the profile 18 and menu item ordering continuing as described above. From time to time the user may wish to make particular edits to the menu items and shortcuts. For this purpose, the edit mode module 1026 provides an edit mode. When the IVR interaction system 16 accesses a particular profile 18 in edit mode, it does not actually place a call to the IVR system 20. The menu tree and user experience is very nearly identical to the user experience in call mode, but with the exception that the user hears no actual audible information, as there is no actual connection to the IVR system 20 and no transactions are actually performed.

Edit mode provides many more options to the user than are available in “call mode” with respect to providing modifications and customizations. In edit mode the menu tree is displayed for the user and the user makes menu item selections as is done when the IVR system 20 is actually connected to the IVR interaction system 16. The user also provides user input when prompted to do so. In edit mode the user may choose to edit any menu item (including shortcuts). With a menu item selected the user accesses an options menu which provides the user with the option to hide and unhide menu items and to delete entry and sequence shortcuts.

Note that if the user deletes an entry shortcut, then any sequence shortcut that references the entry shortcut will be deleted. Hidden menu items will not appear in the menu lists except in edit mode in which case they can appear grayed out. In edit mode the IVR interaction system 16 also allows the user to change the relative location of menu items within a menu list (e.g., to move a particular menu item to the location second from the top of the menu list, to move it down by one item or to move it up by one item, etc.)

In another example of the IVR interaction system 16, a text to speech module 1024 incorporates a form of text to speech so that the user can enter items such as the frequent flyer number (e.g., 2YJ4007) in text format based on prompts provided by the IVR interaction system 16. Using the text to speech module 1024, the IVR interaction system 16 converts such text to speech to be sent to the IVR system 20. The text to speech module 1024 can accomplish this by storing waveform audio files (WAV), motion pictures expert group files (MPEG), audio video interleave files (AVI), MPEG layer 3 files (MP3), enhanced variable rate CODEC (EVRC; in which case a CODEC residing on the phone is used), or similar files for each letter and number, for example, or by other means. Note also that in one example of the IVR interaction system 16, user voice input for items such as the frequent flyer number described above may be recorded by the system for later playback to the IVR system 20. These methods in effect allow for the generation of voice entry shortcuts.

A PC interface generation module 1028 provides a personal computer (PC) version of the IVR interaction system 16. The PC version can provide a rendered image of a cellular phone, PDA, pager, etc., on the PC display. The user is able to operate the IVR interaction system 16 in much the same way as the client device 12 version of the IVR interaction system 16. The user places calls using either an internal or external voice capable analog modem. The PC renders the user interface on the PC display within the confines of the cellular phone, PDA, or pager display portion of the rendered image. User button presses are simulated using the PC mouse, which is placed and pressed on the rendered images of the keys within the image.

With the PC version of the IVR interaction system 16, the PC interface generation module 1028 provides a “control box,” which allows the user to enter user preferences information, to set up call logging, to view a contacts list, and to view the available profiles 18, etc. For the PC version of the IVR interaction system 16 all profiles 18, user profiles, call logs, user preference information, etc., are stored in a pre-determined set of file folders for easy access by the user/developer. In the PC version of the IVR interaction system 16 the profiles 18 are easily added to user profiles by moving the appropriate XML (or other) file associated with the profile 18 into an “profiles” folder within the desired user profile folder. Note that the user will for some profiles have the option to have a launch icon for such a profile placed in the client device 12 screen/desktop so that the IVR interaction system 16 may be launched with a particular profile with “one click”.

In another example of the IVR interaction system 16 users interface more effectively with Internet sites. In this example of the IVR interaction system 16, the majority of the features described above and the general look and feel of the IVR interaction system 16 and user interface are preserved (e.g., sequence shortcuts, entry shortcuts, menu item reordering, edit mode, security features, etc.). This version of the IVR interaction system 16 provides access to unmodified Internet sites as well as to Internet sites which are modified to provide further enhanced features. When the IVR interaction system 16 accesses Internet sites it may utilize the server 10 which resides between the user's client device 12 and the Internet site(s) of interest. The communication between the client device 12 and the server 10 can be via a circuit voice call with DTMF tones to and from, via a data call with data communication to and from, or by way of text (SMS) messaging with communication to and from.

In some PC based and mobile based web browsing, the user is provided with a telephone number for a corporation or other institution and the user may “click” on the telephone number on a particular web site from the web browser—causing the telephone number to be dialed and a telephone connection to be made. In the case where this call terminates at an IVR system 20, the user will necessarily switch from web based browsing to interaction with the IVR system 20 with all of the limitations described above for existing IVR systems 20.

In one example, the IVR interaction system 16 supports a productized PC based version of the IVR interaction system 16, which allows the user to access such IVR systems 20 described above. In such a case, the user interface provided by the IVR interaction system 16 has the same look and feel as it does on the client device 12. After a user “clicks” on the telephone number of the IVR system 20, the IVR interaction system 16 is launched (assuming the appropriate profile 18 is available).

The user then, for the duration of the call, uses the IVR interaction system 16 and user interface in order to complete the desired transactions. Note that in the case where the profile 18 for the particular IVR system 20 is not present on the PC, the IVR interaction system 16 queries the server 10 to determine if the profile 18 for the particular telephone number is available. If the profile 18 is available then the profile 18 is downloaded to the PC and before the call is made to the IVR system 20. Such calls made from the PC would typically be voice over Internet protocol (VoIP) calls, although there is no limitation to making analog voice based calls into the IVR system 20 using the above mentioned PC version of the IVR interaction system 16, or using the IVR interaction system 16.

Those of skill will appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular IVR interaction system and design constraints imposed on the overall system. Skilled persons can implement the described functionality in varying ways for each particular IVR interaction system, but such implementation decisions should not be interpreted as causing a departure from the scope of the invention. In addition, the grouping of functions within a module, block or step is for ease of description. Specific functions or steps can be moved from one module or block to another without departing from the invention.

The various illustrative logical blocks and modules described in connection with the embodiments disclosed herein can be implemented or performed with a general purpose processor, a digital signal processor (DSP), an integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in random access memory (RAM), flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as IVR interaction system specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for interacting with an interactive service system comprising:
processing a profile that represents a process implemented by the interactive service system;
generating a user interface based on the processing of the profile to solicit a user response correlating to a response required by the interactive service system;
receiving the user response via the user interface;
updating the user interface using the profile based on the user response;
communicating with the interactive service system based on the user response.

2. The method of claim 1 further comprising determining from the profile whether the user response requires the signal to be sent to the interactive service system.

3. The method of claim 1 further comprising determining whether a time period has elapsed when the user response requires the signal to be sent to the interactive service system.

4. The method of claim 1 wherein the step of sending a communication comprises causing the generation of a dual tone, multi frequency (DTMF) signal by a telephone network.

5. The method of claim 1 wherein the step of processing a profile further comprises executing an interactive service system interaction system.

6. The method of claim 5 further comprising downloading the interactive service system interaction system and the profile to a client device.

7. The method of claim 1 wherein generating a user interface further comprises presenting the user interface on a display of a client device.

8. The method of claim 1 further comprising
saving the user's response;
using the saved user's response in a subsequent processing of the profile.

9. The method of claim 1 further comprising receiving a signal from the interactive service system.

10. The method of claim 9 wherein the signal from the interactive service system is an audible signal.

11. The method of claim 1 further comprising:
establishing a connection between a client device and the interactive service system.

12. The method of claim 10 further comprising muting a volume associated with the audible signal received from the interactive service system.

13. The method of claim 12 further comprising unmuting the volume associated with the audible signal from the interactive service system when the audible signal is determined to be of interest to a user.

14. The method of claim 1, wherein communicating with the interactive service system includes communicating with an intermediate server which in turn communicates with the interactive service system.

15. The method of claim 1 further comprising:
intercepting a communication to the interactive service system; and
selecting the profile associated with the interactive service system based upon the intercepted communication.

16. The method of claim 1, wherein the profile specifies communication with the interactive service provider over at least one of a voice channel, a data channel, and an SMS channel.

17. A system for interacting with an interactive service system comprising:
a profile processing module which processes a profile that represents a script implemented by an interactive service system;
a user interface generation module configured to generate a user interface based on the processing of the profile to solicit a user response correlating to a response required by the interactive service system;
an input module which receives the user response via the user interface and processes the user response and causes an updated user interface to be generated; and
an output module which sends a signal to the interactive service system based on the user response.

18. The system of claim 17 wherein the profile processing module is further configured to determine from the profile whether the user response requires the signal to be sent to the interactive service system.

19. The system of claim 17 wherein the profile processing module is further configured to determine whether a time period has elapsed when the user response requires the signal to be sent to the interactive service system.

20. The system of claim 19 wherein the determination by the profile processing module of whether a time period has elapsed further comprises the profile processing module determining a time period associated with a prior user response that required a signal to be sent to the interactive service system and the profile processing module determining whether the time period associated with the prior user response has elapsed.

21. The system of claim 17, wherein the output module sends a signal to an intermediate server which in turn sends a signal to the interactive service system.

22. The system of claim 17 further comprising:
an interception module which intercepts a communication to the interactive service system; and
selects the profile associated with the interactive service system based upon the intercepted communication.

23. The system of claim 17, wherein the profile specifies communication with the interactive service provider over at least one of a voice channel, a data channel, and an SMS channel.

24. A method for interacting with an interactive service system comprising:
processing a profile that represents a script implemented by the interactive service system;
generating a user interface based on a profile that represents a script implemented by the interactive service system to solicit a user response correlating to a response required by the interactive service system implementing the script;
receiving a user response via the user interface;
generating and transmitting a communication to the interactive service system based on the user response;
receiving a communication from the interactive service system; and
updating the user interface using the profile based on the communication from the interactive service system.

25. The method of claim 24 further comprising determining from the profile whether the user response requires the signal to be sent to the interactive service system.

26. The method of claim 24 further comprising determining whether a predetermined time period has elapsed before transmitting a communicating to the interactive service system based on the user response.

27. The method of claim 24 further comprising saving information entered by the user and updating the profile using the saved information.

28. The method of claim 24, wherein the communication to the interactive service system is transmitted first to an intermediate server which in turn transmits the communication to the interactive service system.

29. The method of claim 24 further comprising:
intercepting a communication to the interactive service system; and
selecting the profile associated with the interactive service system based upon the intercepted communication.

30. The method of claim 24, wherein the profile specifies communication with the interactive service provider over at least one of a voice channel, a data channel, and an SMS channel.
